(19) United States
(12) Patent Application Publication
(10) Pub. No.: US 2014/0170457 A1
(43) Pub. Date: Jun. 19, 2014

(54) Redox Additive for Secondary Cells with Liquid-Solid Phase Change

(71) Applicants: Marcus Wegner, Leonberg (DE); Jens Grimminger, Leonberg (DE); Martin Tenzer, Unterensingen (DE); Jake Christensen, Mountain View, CA (US)

(72) Inventors: Marcus Wegner, Leonberg (DE); Jens Grimminger, Leonberg (DE); Martin Tenzer, Unterensingen (DE); Jake Christensen, Mountain View, CA (US)

(21) Appl. No.: 13/981,992

(22) PCT Filed: Nov. 28, 2011
(86) PCT No.: PCT/EP2011/071201

§ 371 Date: Nov. 12, 2013

(30) Foreign Application Priority Data
Jan. 26, 2011 (DE) 10 2011 003 197.9

(51) Int. Cl. H01M 10/42

(52) U.S. Cl. CPC H01M 10/4235
USPC 429/102; 564/441; 568/332; 556/143; 585/26

(57) ABSTRACT

A secondary cell, in particular a lithium-sulfur cell, that encompasses a cathode having an electrochemically active cathode active material, an anode having an electrochemically active anode active material, and a liquid electrolyte, the cathode active material and/or anode active material changing, in the context of the charging or discharging operation, from a solid phase form into a liquid phase form that is soluble in the electrolyte. To increase the charging/discharging rate and cycle stability and to decrease overvoltages, the secondary cell encompasses at least one redox additive that is soluble in reduced form and oxidized form in the electrolyte and that is suitable for reacting with the phase-changing electrode active material in a redox reaction in such a way that the electrode active material is convertible from the solid phase form into the liquid phase form.

### FIELD OF THE INVENTION

The present invention relates to a secondary cell, and to the use of a redox additive.

### BACKGROUND INFORMATION

Lithium-sulfur cells are of particular interest, in particular for supplying energy in electric vehicles, because of their high theoretical specific capacity (1672 mAh/g).

Lithium-sulfur cells are based on the overall chemical reaction Li+S₈ [symbol] Li₂S, which proceeds via several intermediate stages during which polysulfides having sulfur chains of various lengths are formed. Polysulfides having a chain length of three to eight sulfur atoms are readily soluble in the electrolytes presently used, for example DME/DOL/LiTFSI mixtures. The intermediate product Li₂S₂ and the end product Li₂S are only poorly soluble in the electrolytes presently used, however, and precipitate as solids during the discharging operation. Electrical contact to the Li₂S₂ solids and Li₂S solids can thereby be lost, with the result that in subsequent charging operations, the precipitated Li₂S₂ and Li₂S can be reacted only partially, or not at all, back to elemental lithium and sulfur. In addition, Li₂S₂ and Li₂S exhibit poor electrical conductivity and therefore high electrical resistance.

### SUMMARY OF THE INVENTION

The subject matter of the present invention is a secondary cell (secondary battery or rechargeable battery) that encompasses a cathode having an electrochemically active cathode active material, an anode having an electrochemically active anode active material, and a liquid electrolyte, the cathode active material and/or anode active material changing, in the context of the charging or discharging operation, from a solid phase form into a liquid phase form that is soluble in the electrolyte. The solid phase form of the phase-changing active electrode material can be, in particular, insoluble or almost insoluble in the electrolyte. A secondary cell of this kind can be, for example, an alkali-sulfur cell, in particular a lithium-sulfur cell, or can refer to cells having lead, iron, zinc, and/or manganese as an anode active material and lead oxide, manganese oxide, titanium oxide, nickel oxide, and/or cobalt oxide as a cathode active material.

According to the present invention, the secondary cell furthermore encompasses at least one redox additive that is soluble in reduced and oxidized form in the electrolyte and that is suitable for reacting with the phase-changing electrode active material in a redox reaction in such a way that the electrode active material is convertible or becomes converted from the solid phase form into the liquid phase form.

The invention is based on the recognition that the conversion of the solid phase form, for example of Li₂S and Li₂S₂, into the liquid phase form, for example polysulfides having a chain length of three to eight sulfur atoms, is the limiting factor in such secondary cells, and that it slows down the reaction kinetics of the overall reaction (for example, Li+S₈ [symbol] Li₂S), results in overvoltages that become increasingly higher over multiple charging/discharging cycles, and limits the cycle stability of the secondary cell. This is explained in detail in connection with the description of FIG. 1.

It has become apparent in the context of the present invention that the conversion of the solid phase form into the liquid phase form can be appreciably accelerated by adding a redox additive that is soluble in both reduced and oxidized form in the electrolyte and is thus mobile and can enter into a redox reaction with the immobile solid phase form of the phase-changing electrode active material, in which reaction the electrode active material is converted into the mobile liquid phase form. This is explained in detail in connection with the description of FIG. 2.

The ultimate result is that thanks to the redox additive according to the present invention, the reaction kinetics of the overall reaction, for example, Li+S₈ [symbol] Li₂S, and thus the charging/discharging rate of the secondary cell, are advantageously improved, overvoltages in the context of the charging/discharging operation are decreased, and cycle stability is increased.

In the context of an embodiment, the cathode active material changes, in the context of the charging operation, from a solid phase form, for example dilithium sulfide (Li₂S) or dilithium disulfide (Li₂S₂), into a liquid phase form soluble in the electrolyte, for example polysulfides having a chain length of three to eight sulfur atoms. The redox additive may be suitable for reacting with the phase-changing cathode active material in a redox reaction in such a way that the cathode active material is convertible or becomes converted from the solid phase form into the liquid phase form.

In the context of a further embodiment, the cathode active material changes, in the context of the charging operation, from a reduced solid phase form, for example dilithium sulfide (Li₂S) or dilithium disulfide (Li₂S₂), into an oxidized liquid phase form, for example polysulfides having a chain length of three to eight sulfur atoms. The oxidized form of the redox additive may be suitable for reacting with the reduced solid phase form of the cathode active material, for example dilithium sulfide (Li₂S) or dilithium disulfide (Li₂S₂), accompanied by reduction of the redox additive to the reduced form and oxidation of the cathode active material to the oxidized liquid phase form, for example polysulfides having a chain length of three to eight sulfur atoms.

In the context of a further embodiment, in particular in the case of a cathode active material that changes, in the context of the charging operation, from a solid phase form, for example dilithium sulfide (Li₂S) or dilithium disulfide (Li₂S₂), into a liquid phase form soluble in the electrolyte, for example polysulfides having a chain length of three to eight sulfur atoms, the redox potential of the redox additive is higher/more positive than the redox potential of the solid phase form/liquid phase form redox pair of the phase-changing cathode active material. It is thereby possible to ensure, advantageously, that the redox additive reacts with the phase-changing electrode active material in a redox reaction in which the electrode active material is converted from the solid phase form into the liquid phase form.

The redox potential of the redox additive should preferably not, however, be higher/more positive than the sum of the magnitude of the, in particular initial, cathode overvoltage and the redox potential of the solid phase form/liquid phase form redox pair of the phase-changing cathode active material.

In the context of a further embodiment, in particular in the case of a cathode active material that changes, in the context of the charging operation, from a solid phase form, for example dilithium sulfide (Li₂S) or dilithium disulfide (Li₂S₂), into a liquid phase form soluble in the electrolyte, for example polysulfides having a chain length of three to eight sulfur atoms, the redox potential of the redox additive is therefore lower/more negative than the sum of the redox potential of the solid phase form/liquid phase form redox pair of the phase-changing cathode active material and the magnitude of the, in particular initial, cathode overvoltage. Advantageously, the overvoltage can thereby be lowered and the cycle stability improved.

In the context of a further embodiment, in particular in the case of a cathode active material that changes, in the context of the charging operation, from a solid phase form, for example dilithium sulfide (Li₂S) or dilithium disulfide (Li₂S₂), into a liquid phase form soluble in the electrolyte, for example polysulfides having a chain length of three to eight sulfur atoms, the redox potential of the redox additive is from ≧50 mV to ≦200 mV higher/more positive than the redox potential of the solid phase form/liquid phase form redox pair of the phase-changing cathode active material. The use of a redox additive whose redox potential is from ≧50 mV to ≦200 mV higher/more positive than the redox potential of the solid phase form/liquid phase form redox pair of the phase-changing cathode active material has proven advantageous in particular for lithium-sulfur cells, since with these cells the initial cathode overvoltage is usually higher than 200 mV.

In the case of lithium-sulfur cells, for example, the redox potential of the redox additive, referred in particular to Li/Li⁺, can be less than 2.55 V, for example less than or equal to 2.5 V or 2.45 V or 2.4 V or 2.35 V. In the case of lithium-sulfur cells, for example, the redox potential of the redox additive, referred in particular to Li/Li⁺, can be in a range from ≧2.0 V to ≦2.3 V, for example from ≧2.1 V to ≦2.2 V.

Alternatively or additionally, the cathode active material can change, in the context of the discharging operation, from a solid phase form, for example solid sulfur, into a liquid phase form soluble in the electrolyte, for example polysulfides having a chain length of three to eight sulfur atoms. In this case the redox additive may be suitable for reacting with the phase-changing cathode active material in a redox reaction in such a way that the cathode active material is convertible or becomes converted from the solid phase into the liquid phase form. For example, the cathode active material can change, in the context of the discharging operation, from an oxidized solid phase form, for example solid sulfur, into a reduced liquid phase form, for example polysulfides having a chain length of three to eight sulfur atoms.

The reduced form of the redox additive may be suitable for reacting with the oxidized solid phase form of the cathode active material, for example solid sulfur, accompanied by oxidation of the redox additive to the oxidized form and reduction of the cathode active material to the reduced liquid phase form, for example polysulfides having a chain length of three to eight sulfur atoms. In this case the redox potential of the redox additive may be lower/more negative than the redox potential of the solid phase form/liquid phase form redox pair of the phase-changing cathode active material and/or higher/more positive than the difference between the redox potential of the solid phase form/liquid phase form redox pair of the phase-changing cathode active material and the magnitude of the, in particular initial, cathode overvoltage. For example, the redox potential of the redox additive can be from ≧50 mV to ≦200 mV lower/less negative than the redox potential of the solid phase form/liquid phase form redox pair of the phase-changing cathode active material.

Alternatively or additionally, the anode active material can change, in the context of the charging operation, from a solid phase form into a liquid phase form soluble in the electrolyte. In this case the redox additive may be suitable for reacting with the phase-changing anode active material in a redox reaction in such a way that the anode active material is convertible or becomes converted from the solid phase form into the liquid phase form. For example, the anode active material can change, in the context of the charging operation, from an oxidized solid phase form into a reduced liquid phase form. The reduced form of the redox additive may be suitable for reacting with the oxidized solid phase form of the anode active material, accompanied by oxidation of the redox additive to the oxidized form and reduction of the anode active material to the reduced liquid phase form.

In this case the redox potential of the redox additive may be lower/more negative than the redox potential of the solid phase form/liquid phase form redox pair of the phase-changing anode active material, and/or higher/more positive than the difference between the redox potential of the solid phase form/liquid phase form redox pair of the phase-changing anode active material and the magnitude of the, in particular initial, anode overvoltage. For example, the redox potential of the redox additive can be from ≧50 mV to ≦200 mV lower/less negative than the redox potential of the solid phase form/liquid phase form redox pair of the phase-changing anode active material.

Alternatively or additionally, the anode active material can change, in the context of the discharging operation, from a solid phase form, for example metallic lithium, lead, iron, zinc, and/or manganese, into a liquid phase form soluble in the electrolyte, for example ionic lithium, lead, iron, zinc, and/or manganese. In this case the redox additive may be suitable for reacting with the phase-changing anode active material in a redox reaction in such a way that the anode active material is convertible or becomes converted from the solid phase form into the liquid phase form. For example, the anode active material can change, in the context of the discharging operation, from a reduced solid phase form into an oxidized liquid phase form. The oxidized form of the redox additive may be suitable for reacting with the reduced solid phase form of the anode active material, accompanied by reduction of the redox additive to the reduced form and oxidation of the anode active material to the oxidized liquid phase form.

In this case the redox potential of the redox additive may be higher/more positive than the redox potential of the solid phase form/liquid phase form redox pair of the phase-changing anode active material, and/or lower/more negative than the sum of the redox potential of the solid phase form/liquid phase form redox pair of the phase-changing anode active material and the magnitude of the, in particular initial, anode overvoltage. For example, the redox potential of the redox additive can be from ≧50 mV to ≦200 mV higher/less negative than the redox potential of the solid phase form/liquid phase form redox pair of the phase-changing anode active material.

The redox reaction between the redox additive and the electrode active material, in particular the cathode active material and anode active material respectively, which may be exhibits a high degree of reversibility, for example a coulombic efficiency close to 100%, in particular ≧99.99%, and a higher reaction rate than the redox reaction of the solid phase form/liquid phase form redox pair of the electrode active material, in particular of the cathode active material and anode active material, respectively.

The redox additive preferably does not enter into any reaction with the electrolyte, with the counterelectrode active material, or with other cell components. To the extent that the redox additive can react with the counterelectrode active material, the latter can be protected from reacting with the redox additive by a, for example polymeric or ceramic, or combined polymer/ceramic, protective layer.

In the context of a further embodiment, the cathode active material is sulfur.

In the context of a further embodiment, the anode active material is lithium.

In the context of a further embodiment, the reduced solid phase form of the cathode active material is dilithium sulfide (Li₂S) and/or dilithium disulfide (Li₂S₂).

In the context of a further embodiment, the redox additive is an organic or organometallic compound, in particular an aromatic organic or organometallic compound.

In the context of a further embodiment, the redox additive is selected from the group consisting of nitrobenzene, benzophenone, naphthalene, metallocenes, and combinations thereof. Redox additives of this kind have proven advantageous for lithium-sulfur cells. For example, nitrobenzene, benzophenone, and metallocenes are suitable for oxidizing dilithium sulfide (Li₂S) and/or dilithium disulfide (Li₂S₂) to polysulfides having a chain length of three to eight sulfur atoms, since nitrobenzene (Ph-NO₂) has a redox potential of 2.2765 V with respect to lithium in DMF with 0.1 M NAClO₄, and a redox potential of 2.1365 V with respect to lithium in acetonitrile with 0.2 M tetraethylammonium perchlorate (TEAP); benzophenone (Ph-COPh) has a redox potential of 2.0565 V with respect to lithium in ammonia with 0.1 M KI at −50° C.; naphthalene has a redox potential of 2.0 V with respect to lithium in (polyethylene oxide)*LiTFSI; and metallocenes, for example cobaltocene (bis(cyclopentadienyl) cobalt) has a redox potential range from 1.70 V to 2.2 V with respect to lithium.

The redox potential can be adjusted by way of substituents on the aromatic ring or rings. With metallocenes, the redox potential can additionally be adjusted by way of the type of metal ion. The aforesaid redox potentials of the group consisting of nitrobenzene, benzophenone, naphthalene, and metallocenes were measured with reference to an aqueous calomel electrode, and then recalculated with respect to Li/Li⁺. It has been found, however, that the solvent has almost no influence on the redox potential.

The electrolyte can encompass one or more solvents that are selected, for example, from the group consisting of carbonic acid esters such as ethylene carbonate (EC), propylene carbonate (PC), dimethyl carbonate (DMC), diethyl carbonate (DEC) vinylene carbonate (VC), lactones such as γ-butyrolactone (GBL), ethers, in particular cyclic or acyclic ethers, such as 1,3-dioxolan (DOL) or dimethyl ether/ethylene glycol dimethyl ether (DME); polyethers such as tetraethylene glycol dimethyl ether, and combinations thereof. The electrolyte can moreover encompass one or more conductive salts that are selected, for example, from the group consisting of lithium bis(trifluoromethylsulfonyl)imide (LiTFSI), lithium hexafluorophosphate (LiPF₆), lithium tetrafluoroborate (LiBF₄), lithium trifluoromethanesulfonate (LiCF₃SO₃), lithium perchlorate (LiClO₄), lithium bis(oxalato)borate (LiBOB), lithium fluoride (LiF), lithium nitrate (LiNO₃), lithium hexafluoroarsenate (LiAsF₆), and combinations thereof.

Besides the cathode active material and anode active material, the electrodes can also encompass further components, for example conductive additives such as graphite and/or carbon black, and/or binders such as polyvinylidene fluoride (PVDF).

Secondary cells according to the present invention, in particular lithium-sulfur cells, can be used, for example, in notebooks, PDAs, tablet computers, mobile telephones, electronic books, electric power tools, garden tools, and vehicles, such as hybrid, plug-in hybrid, and electric vehicles.

With regard to further features and advantages of the secondary cell according to the present invention, reference is hereby explicitly made to the explanations in conjunction with the use according to the present invention, and to the description of the Figures.

A further subject of the present invention is the use of an, in particular organic or organometallic, for example organic or organometallic aromatic, redox additive, for example of nitrobenzene and/or benzophenone and/or naphthalene and/or one or more metallocenes, to lower an overvoltage and/or to raise the charging/discharging rate and/or to enhance the cycle resistance of a secondary cell having an electrode active material, in particular cathode active material, that changes, in the context of the charging or discharging operation, from a solid phase form into a liquid phase form soluble in an electrolyte, for example of an alkali-sulfur cell, in particular of a lithium-sulfur cell, in particular such that the redox additive is soluble in the electrolyte and is suitable for reacting with the phase-changing electrode active material in a redox reaction in such a way that the electrode active material is converted from the solid phase form into the liquid phase form.

With regard to further features and advantages of the use according to the present invention, reference is hereby explicitly made to the explanations in conjunction with the secondary cell according to the present invention, and to the description of the Figures.

Further advantages and advantageous embodiments of the subject matters according to the present invention are illustrated by the drawings and explained in the description that follows. Be it noted in this regard that the drawings are of a descriptive nature only, and are not intended to limit the invention in any way.

### BRIEF DESCRIPTION OF THE DRAWINGS

FIG. 1 shows a graph to illustrate the voltage curve for a charging experiment on a lithium-sulfur cell that has previously already been repeatedly charged and discharged.

FIG. 2 schematically depicts the functional principle of a redox additive according to the present invention with a solid/liquid phase-changing electrode active material.

### DETAILED DESCRIPTION

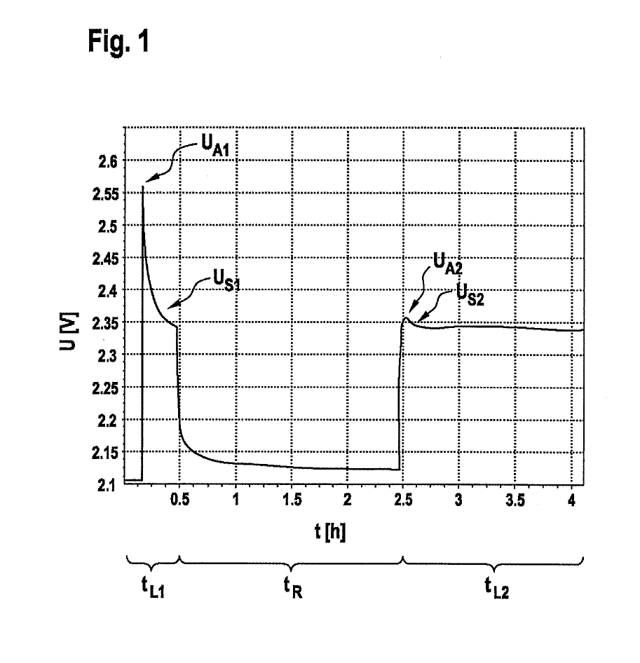

FIG. 1 shows the voltage curve for a charging experiment on a lithium-sulfur cell that has already been repeatedly charged. FIG. 1 shows that at the beginning of the charging operation in a first charging phase t_{L1}, a high initial overvoltage occurs which then decreases again (U_{S1}). FIG. 1 further illustrates that when the first charging phase t_{L1} is then terminated and a second charging phase t_{L2} is begun after a certain relaxation time t_{R} (here 2 hours) has elapsed, the initial overvoltage U_{A2} of the second charging phase t_{L2} is lower than the initial overvoltage U_{A1} of the first charging phase t_{L1}, and the voltage drop Uₛ₂ of the second charging phase t_{L2} is less significant than the voltage drop U_{S1} of the first charging phase t_{L1}.

With no intention of settling on one theory in this context, this can be explained by the fact that in the completely discharged state, Li₂S₂ and Li₂S are present as an immobile solid having a low electrical conductivity, which results in a high initial overvoltage U_{A1} in the first charging phase t_{L1}. In the charging operation, a portion of the Li₂S₂ and Li₂S becomes oxidized to short-chain polysulfides that are soluble in the electrolyte and thus mobile, and which are capable of getting close to current-conducting structures of the cell, for example graphite and/or carbon-black structures, at which the polysulfides are further oxidized to longer-chain, likewise mobile polysulfides. The longer-chain polysulfides, for example Li₂S₄, can then in turn comproportionate with the Li₂S₂ and Li₂S to yield shorter-chain mobile polysulfides, for example 2 Li₂S₄+Li₂S [symbol] 3 Li₂S₃. The mobile comproportionation products, for example Li₂S₃, can then once again come close to the current-conducting structures, at which they become oxidized to longer-chain mobile polysulfides that can in turn comproportionate with further Li₂S₂ and Li₂S.

The mobile polysulfides can consequently function as a kind of internal catalyst, which transfers electrons from the Li₂S₂ and Li₂S to the current-conducting structures. The concentration of the mobile polysulfides rises during the charging operation, which explains the voltage drop Uₛ₁. During the relaxation phase t_{R}, the longer-chain mobile polysulfides can comproportionate further with Li₂S₂ and Li₂S to yield shorter-chain mobile polysulfides. More mobile reaction partners are therefore available during the second charging phase t_{L2} than during the first charging phase t_{L1}, with the result that the initial overvoltage U_{A2} of the second charging phase t_{L2} is lower than the initial overvoltage U_{A1} of the first charging phase, and the voltage drop Uₛ₂ of the second charging phase t_{L2} is less significant than the voltage drop U_{S1} of the first charging phase t_{L1}.

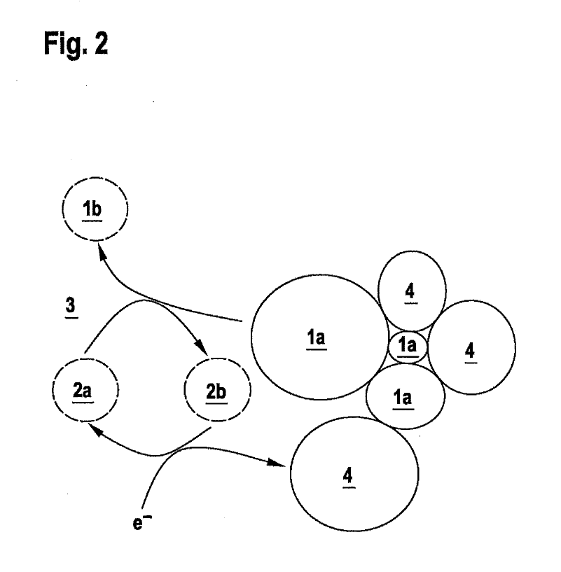

FIG. 2 illustrates the functional principle of a redox additive according to the present invention with a solid/liquid phase-changing electrode active material. The functional principle will be explained below using the example of a lithium-sulfur cell. The explanation with reference to a lithium-sulfur cell is intended to serve only for better elucidation, and is not to be utilized to limit the invention to this type of secondary cell and to sulfur as a cathode active material.

FIG. 2 shows that the lithium-sulfur cell has a cathode active material that is converted, in the context of the charging operation, from a solid phase form 1a that is soluble very little or not at all in electrolyte 3, namely Li₂S and/or Li₂S₂, into a liquid phase form 1b soluble in electrolyte 3, namely polysulfides having a chain length of three to eight sulfur atoms. This reaction can, however, be kinetically inhibited in particular for lack of electrical contact with current-conducting structures 4, such as graphite and/or carbon black, and/or because the electrode active material has a large particle size, and/or due to low electrical conductivity of the electrode active material. This kinetic inhibition can be eliminated by way of redox additive 2a, 2b according to the present invention, which in both its oxidized form 2a and its reduced form 2b is soluble in electrolyte 3 and thus mobile.

In the case of a lithium-sulfur cell, for example, the dissolved oxidized form 2a of the redox additive, for example of nitrobenzene, benzophenone, naphthalene, or a metallocene, can be formed directly after the beginning of the charging operation, and then reacts quickly with the undissolved and therefore immobile solid phase form 1a of the cathode active material accompanied by formation of liquid phase form 1b. In particular, solid Li₂S and/or Li₂S₂ 1a can be oxidized to soluble polysulfides having a chain length of three to eight sulfur atoms 1b, and the oxidized form of redox additive 2a can be reduced to reduced form 2b. The redox additive can be oxidized again, and can thus serve as a catalyst. Soluble polysulfides 1b can diffuse to the current-conducting structures of the secondary cell, at which they can be further oxidized and can subsequently comproportionate with further Li₂S and/or Li₂S₂ and serve as a further catalyst.

Thanks to the reaction with the redox additive according to the present invention, advantageously even poorly bound or unbound electrode active material in solid phase form 1a, such as Li₂S and/or Li₂S₂, can be converted quickly into liquid phase form 1b, such as soluble polysulfides. The result is that, advantageously, the reaction kinetics of the overall reaction can be improved, the overvoltage lowered, and the cycle stability increased.

The principle according to the present invention is applicable to any electrode active material changing between a solid and a liquid phase in the context of the charging operation or the discharging operation, i.e. also to anode active materials and to redox reactions in which the redox additive functions not as an oxidizing agent but as a reducing agent.

1-11. (canceled)

12. A secondary cell, comprising:
a cathode having an electrochemically active cathode active material;
an anode having an electrochemically active anode active material; and
a liquid electrolyte;
wherein the cathode active material and/or anode active material changing, in the context of the charging or discharging operation, from a solid phase form into a liquid phase form that is soluble in the electrolyte, and
wherein the secondary cell encompasses at least one redox additive that is soluble in reduced form and oxidized form in the electrolyte and that is suitable for reacting with the phase-changing electrode active material in a redox reaction so that the electrode active material is convertible from the solid phase form into the liquid phase form.

13. The secondary cell of claim 11, wherein the cathode active material changes, in the context of the charging operation, from a solid phase form into a liquid phase form soluble in the electrolyte, and wherein the redox additive is suitable for reacting with the phase-changing cathode active material in a redox reaction in such a way that the cathode active material is convertible from the solid phase form into the liquid phase form.

14. The secondary cell of claim 11, wherein the cathode active material changes, in the context of the charging operation, from a reduced solid phase form into an oxidized liquid phase form, and wherein the oxidized form of the redox additive is suitable for reacting with the reduced solid phase form of the cathode active material, accompanied by reduction of the redox additive to the reduced form and oxidation of the cathode active material to the oxidized liquid phase form.

15. The secondary cell of claim 11, wherein the redox potential of the redox additive is higher and/or more positive than the redox potential of the solid phase form/liquid phase form redox pair of the phase-changing cathode active material.

16. The secondary cell of claim 11, wherein the redox potential of the redox additive is from ≧50 mV to ≦200 mV higher and/or more positive than the redox potential of the solid phase form/liquid phase form redox pair of the phase-changing cathode active material.

17. The secondary cell of claim 11, wherein the redox potential of the redox additive is lower and/or more negative than the sum of the redox potential of the solid phase form/liquid phase form redox pair of the phase-changing cathode active material and the magnitude of the cathode overvoltage.

18. The secondary cell of claim 11, wherein the cathode active material is sulfur and the anode active material is lithium.

19. The secondary cell of claim 11, wherein the reduced solid phase form of the cathode active material is dilithium sulfide (Li₂S) and/or dilithium disulfide (Li₂S₂).

20. The secondary cell of claim 11, wherein the redox additive is an organic or organometallic compound.

21. The secondary cell of claim 11, wherein the redox additive includes at least one of nitrobenzene, benzophenone, naphthalene, metallocenes, and combinations thereof.

22. A method for lowering an overvoltage and/or raising a charging/discharging rate and/or enhancing a cycle resistance of a secondary cell having an electrode active material that changes, in the context of the charging or discharging operation, from a solid phase form into a liquid phase form soluble in an electrolyte, the method comprising:
using an organic or organometallic redox additive in the electrolyte, wherein the redox additive is soluble in the electrolyte and reacts with the phase-changing electrode active material in a redox reaction so that the electrode active material is converted from the solid phase form into the liquid phase form.

23. The redox additive of claim 22, wherein the additive is aromatic.

24. The redox additive of claim 22, wherein the additive includes at least one of nitrobenzene, benzophenone, naphthalene, and metallocenes,

25. The redox additive of claim 22, wherein the electrode active material is a cathode active material.

26. The redox additive of claim 22, wherein the electrolyte is of an alkali-sulfur cell.

27. The redox additive of claim 22, wherein the electrolyte is of a lithium-sulfur cell.

28. The secondary cell of claim 11, wherein the cell is an alkali-sulfur cell.

29. The secondary cell of claim 11, wherein the cell is an a lithium-sulfur cell.

30. The secondary cell of claim 11, wherein the redox additive is an organic or organometallic aromatic compound.
